(19) United States
(12) Patent Application Publication
(10) Pub. No.: US 2002/0165885 A1
(43) Pub. Date: Nov. 7, 2002

(54) Method and system for verifying translation of localized messages for an internationalized application

(75) Inventors: David Bruce Kumhyr, Austin, TX (US); Hosheng Chao Lee, Wan Chai (HK)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 09/848,170

(22) Filed: May 3, 2001

(51) Int. Cl. G06F 15/00

(52) U.S. Cl. 707/536

(57) ABSTRACT

A method, a system, an apparatus, and a computer program product are presented for facilitating verification of translated messages and strings to be used by a localized version of an internationalized application. An application may employ messages and strings that have been translated into different languages as necessary for different localized versions of the application; prior to releasing or deploying a final version of the application, a user may need to verify that the messages and strings have been translated properly. A translation verification utility obtains a list of one or more source files containing translated messages or strings. The translation verification utility then retrieves the messages or strings, presents the messages or strings to a verifying user through a graphical user interface, and allows the verifying user to step through the translated messages or strings in order to correct any messages or strings that have been translated incorrectly.

### BACKGROUND OF THE INVENTION

1. Field of the Invention

The present invention relates to an improved data processing system and, in particular, to a method and apparatus for a software program development tool. Still more particularly, the present invention provides a method and apparatus for generating internationalized versions of application programs.

2. Description of Related Art

Development of a commercial software application requires significant time and effort. Upon completion, most enterprises desire to generate the largest possible amount of sales for the application, and many enterprises attempt to sell their applications in foreign markets. In order to do so, each application must be adapted in several different manners for different markets, regions, or countries. For example, a North American version of an application would require English menus and dollars for the default currency symbol, while a French version of the application would require French menus and euros for the default currency symbol. Many tasks must be completed in order to localize an application for a particular locale. Dates, times, numbers, and currency values must be displayed in the customary format for the locale. In addition, the application must be able to operate with the local character encoding standard.

Adapting applications for local markets could entail costly and time-consuming modifications to the applications if not performed methodically. To facilitate the task of creating multiple versions of an application for international markets, many commercially available software development tools and runtime environments have been developed with the recognition that applications would need to be adapted to different human languages and other requirements prior to being sold in different regions or countries. The term “internationalization” is used to describe the process of enabling a software application to be used in multiple international markets.

A properly internationalized application comprises functionality that enables it to be used in multiple international markets with only a minimal amount of localization effort. For example, an operating system can allow a user to select locale parameters. Assuming that an application has been created while adhering to certain internationalization guidelines of the particular operating system, the presentation of information by the application can be dynamically adapted to the user's selected locale during runtime.

While certain localization tasks can be rather simple, other localization tasks require significant effort by the application developer. For example, each human language string that might be displayed to a user during the execution of the application must be translated. Switching between languages can be facilitated by the operating system or some other configuration mechanism, but different sets of strings must have been generated and stored beforehand in order to be available to be retrieved at some later time based on a configuration parameter.

An application developer might use a translation program to expedite the task of translating the human language text strings, but both human translators and translation programs may not translate all of the strings correctly or intelligibly. To guard against translation errors, an application developer would generally incorporate translation verification procedures into the overall quality control and testing procedures that are applied to the application that is being developed.

Checking the appearance or correctness of certain application items, such as menus and help files, is rather straightforward, but verifying other items can be relatively difficult. In particular, each error or warning message that might appear during the operation of the application must be verified.

During translation verification testing, a pervasive problem entails operating the application that is being tested in such a manner to display each message so that it may be verified. It is especially difficult to force error messages to be displayed because it is often difficult to generate the operating conditions that would cause the application to display an error message.

Rather than embedding, i.e., hard-coding, human language text within the source code of an application, application text strings, including warning and error messages, are often congregated within certain types of files that are subsequently associated with the application in the runtime environment, such as resource files. Hence, the translated strings that are required to localize an application may be located within one or more files, and these files can be viewed and edited using a typical editor by a person who is verifying the translated strings. If an erroneously translated string were to be found within one of these files, then the person performing the verification could merely edit the string to correct the error.

However, a typical application could comprise thousands of strings and messages, and human scanning of one or more large text files can itself by an error-prone process such that the person performing the verification could easily miss errors within the file.

Therefore, it would be advantageous to have a software tool for facilitating translation verification of strings and messages that are used by a localized version of an application.

### SUMMARY OF THE INVENTION

A method, a system, an apparatus, and a computer program product are presented for facilitating verification of translated messages and strings to be used by a localized version of an internationalized application. Application messages and strings may be stored within one or more source files that are used to develop or support the application; the application messages and strings have been translated into one or more different languages as necessary for different localized versions of the application. Prior to releasing or deploying a final version of the application, a user may need to verify that the messages and strings have been translated properly.

A translation verification utility obtains a list of one or more source files containing translated messages or strings. The translation verification utility then retrieves the messages or strings, presents the messages or strings to a verifying user through a graphical user interface, and allows the verifying user to step through the translated messages or strings in order to correct any messages or strings that have been translated incorrectly. Any other information associated with a message or string within a source file may also be displayed in order to provide the verifying user with additional contextual information that may assist the user in determining the correctness of a particular translated message or string.

The messages or strings are displayed to the verifying user one at a time, and the verifying user may edit a message or string as necessary. The user may review the messages or strings in a substantially sequential, forward manner, thereby moving through the messages or strings from a particular source file starting from a first message or string in the source file and proceeding to a final message or string in the source file. The translation verification utility may also present additional controls for allowing a user to move forwards or backwards through the messages or strings either in a substantially sequential manner or a substantially non-sequential manner.

The translation verification utility may track the actions of the verifying user in order to assist the user in determining which messages or strings within the one or more source files have not yet been reviewed and/or verified. The tracking information may be logged for subsequent use in multiple review sessions.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIG. 2 is a block diagram depicting some of the logical components that may be used by a translation verification utility in accordance with a preferred embodiment of the present invention;

FIG. 3 depicts a typical source file containing application messages/text strings;

FIGS. 4A-4B depict a set of graphical user interface (GUI) windows in which a user may interact with the translation verification utility of the present invention; and

FIG. 5 is a flowchart depicting a process through which the translation verification utility enables a user to verify translated messages and strings within source files in accordance with a preferred embodiment of the present invention.

### DETAILED DESCRIPTION OF THE INVENTION

The present invention is directed to a system and a methodology for facilitating verification of translated messages and strings to be used by a localized version of an internationalized application. These messages and strings may be obtained from one or more source files that are dispersed throughout a network. As background, a typical organization of hardware and software components within a distributed data processing system is described prior to describing the present invention in more detail.

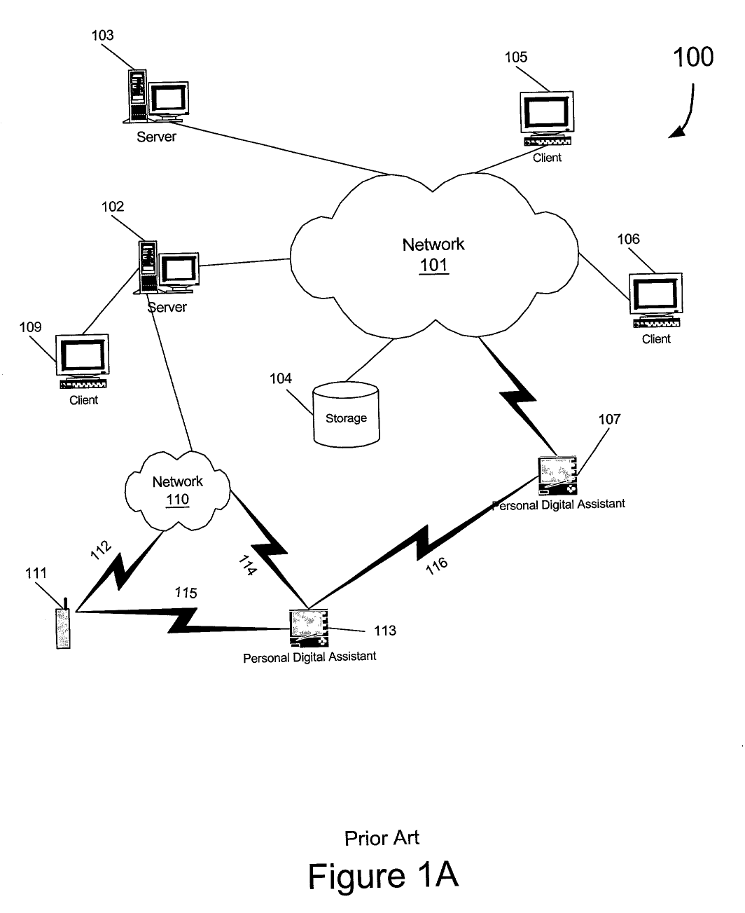

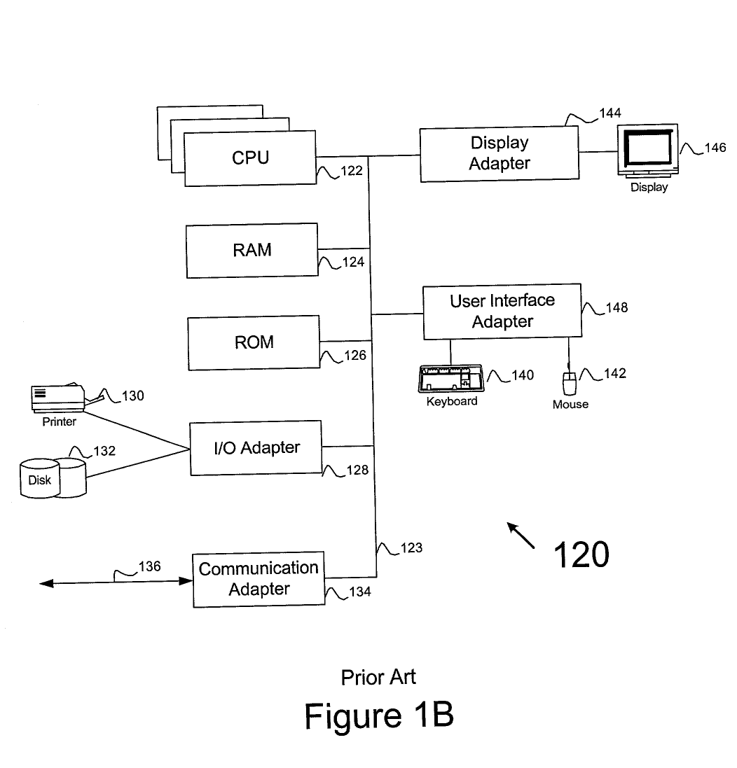

With reference now to the figures, FIG. 1A depicts a typical network of data processing systems, each of which may contain and/or operate the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, including a digital signal processor (DSP) and other types of special purpose processors, and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. More specifically, though, the present invention is directed to a system and a methodology for facilitating verification of translated messages and/or strings to be used by a localized version of an internationalized application as described in more detail with respect to the remaining figures.

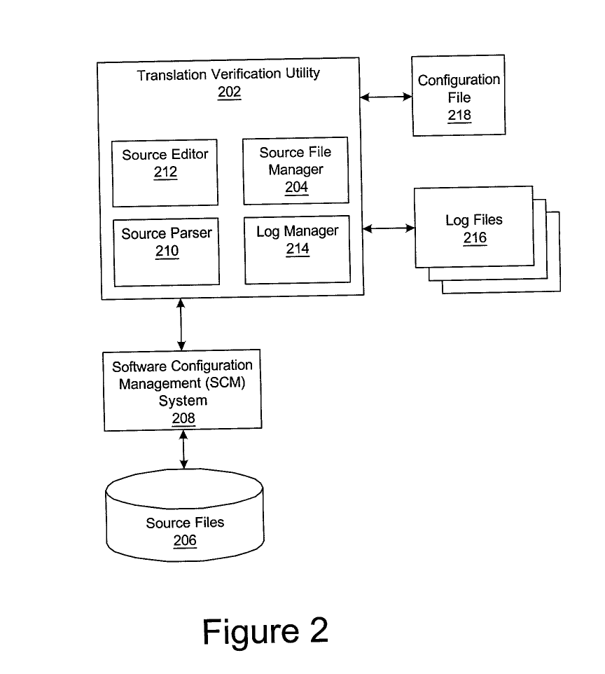

With reference now to FIG. 2, a block diagram depicts some of the logical components that may be used by a translation verification utility in accordance with a preferred embodiment of the present invention. Translation verification utility 202 may contain source file manager 204 for interacting with source files 206 via a software configuration management (SCM) system 208. In many application development environments, source files are often maintained within an SCM system. While initially developing source code modules and associated support files, such as resource files, a software engineer may locally edit and/or compile the source files and has the ability to add or delete files at will without regard to previous versions of those files. The translated messages or strings are stored within one or more source files, which may comprise a variety of file formats as required by a given application development system or runtime environment. Therefore, a source file may be any type of file from which a translated message or string may be retrieved for use by an application. While it may be good programming design to separate application source code from runtime data, a source file may comprise a combination of programming language source code, resource data, e.g., translated messages/strings, etc.

Translated messages may be considered a subset of translated strings in which translated messages are considered a relatively long, informational, text string for informing the user of an error, a warning, or some other type of information item, while a translated string may be a relatively short text string for use as menu items, labels, window titles, or some other application-related user interface item. Hence, with respect to the present invention, the terms “messages” and “strings” may be used interchangeably.

At some point in time, the software engineer determines that the source files meet various predetermined requirements, i.e., the source files appear to perform processing tasks as required without error. The software engineer then submits the source files to the SCM system, which archives the source files and/or manages the source files after that point in time. In summary, the SCM system provides structure and discipline to the modification of source files while an application is being developed.

A separate test engineer may then compile the newly submitted source files with source files from other software engineers to determine whether an application as a whole meets various processing requirements. If processing errors or bugs are found, the test engineer may issue a discrepancy report via the SCM system, and the original software engineer is notified to resolve the problem that is described within the discrepancy report.

In order to maintain the integrity of the overall application while it is being developed, the software engineer then retrieves a copy of the problematic source files via the SCM system, which controls and tracks the source files after their initial submission. The software engineer resolves the problem within the discrepancy report using the controlled copies of the source files, which probably requires modification of the source files. The software engineer then submits the modified copies of the source files to the SCM system. Using the newly modified source files, a test engineer may then rerun a test procedure to determine whether the prior problem within the discrepancy report has been resolved with respect to other source files from other software engineers. In this manner, the overall integrity of all of the source files that comprise the application that is being developed can be maintained.

In a similar manner, each source file that contains translated messages and strings can be managed by SCM system 208. Before a translation verifier may view and possible edit a source file, a copy of the source file is obtained via SCM system 208, which may place a lock on the source file to indicate that the source file is already in use. During the verification process, the source file may be modified. After the translation verification is complete, a modified copy of the source file may be archived via SCM system 208. Otherwise, if no modified copy is generated and the verifier has completed the verification process with respect to a particular source file, the translation verification utility can notify SCM system 208 to release the lock on the source file.

Hence, translation verification utility 202 can interoperate with various SCM system or subsystems as required to manage the source files and maintain the integrity of the application as it is being developed. Source file manager component 204 interfaces with SCM system 208 to retrieve and store source files as necessary. Alternatively, if an application is being developed without the assistance of an SCM system, source file manager component 204 may directly retrieve, modify, and store files for translation verification utility 202 as necessary.

Source parser component 210 contains rules for parsing the source files that contain translated strings and messages to be verified. The source files may be formatted in a variety of ways, and the parser may scan, retrieve, and store information within the source files in an appropriate manner.

As noted above, an application typically does not contain hard-coded messages but instead reads the message during runtime in accordance with a locale parameter. For example, Java provides a mechanism for defining messages as key/value pairs within a “ResourceBundle” subclass, and an application developer can create a “ResourceBundle” for each language or locale that is supported by the application; at runtime, an appropriate method can be used to load the “ResourceBundle” for the current locale. Each message or string is associated with a key that serves as the message/string name, and the application retrieves a locale-dependent message or string using the locale-independent message or string name. For a Java application, source parser 210 would support interfacing with “ResourceBundles” as required.

Source editor 212 obtains translated strings or messages in a sequential manner for presentation to a user who is performing the translation verification. Source editor 212 employs a graphical user interface that allows the user to edit message or other strings to correct erroneous translations.

Log manager 214 generates logging information that may be stored within log files 216. As the translation verifier views and possibly edits the translated messages and strings, the translation verification utility may be optionally configured to track the actions of the user. When a message or string is verified or edited, log manager 214 generates a record of the action and the identity of the user who has performed the action. If errors within the translated messages or strings are detected at some later time, then the logs may be checked to identify how or when the erroneous message was incorrectly verified during the translation verification process. Log files 216 may optionally be incorporated as part of the controlled files associated with an application through SCM system 208.

Translation verification utility 202 may use configuration file 218 for storing configuration parameters that determine the manner in which the translation verification utility operates. Configuration file 218 may also contain user preference parameters.

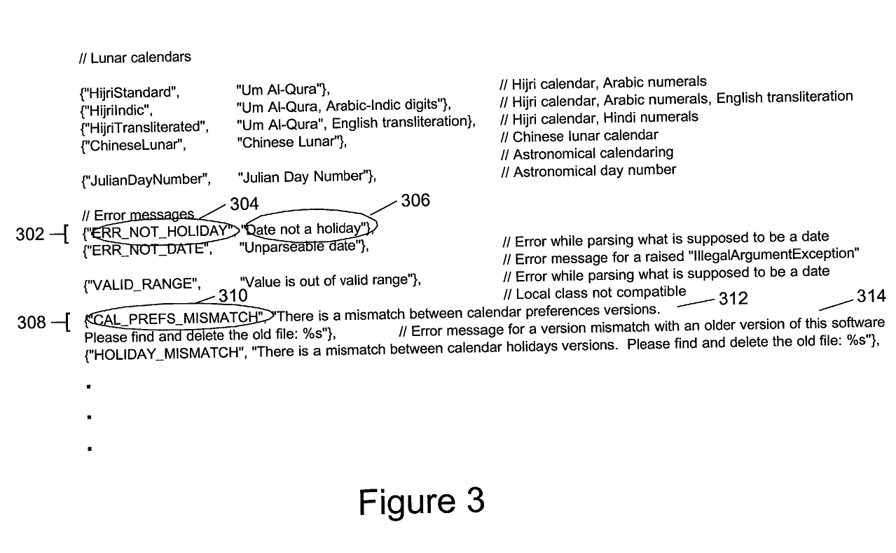

With reference now to FIG. 3, a typical source file that contains application messages is shown. An example of a resource file or a resource bundle contains a set of messages and associated identifiers. Message 302 comprises message key 304 and message text string 306, which contains the word “date”. For the given context of a calendar application, the word “date” could be correctly translated into a foreign language with the meaning “day on which an event occurs” but could also be incorrectly translated with the meaning “edible fruit of a palm tree”. Message 308 comprises message key 310 and error text string 312, which contains a variable string identified by the “%s” substring that allows a value for the substring to be dynamically provided during execution of the application. Comment 314 is associated with message 308 and provides further information about the particular message.

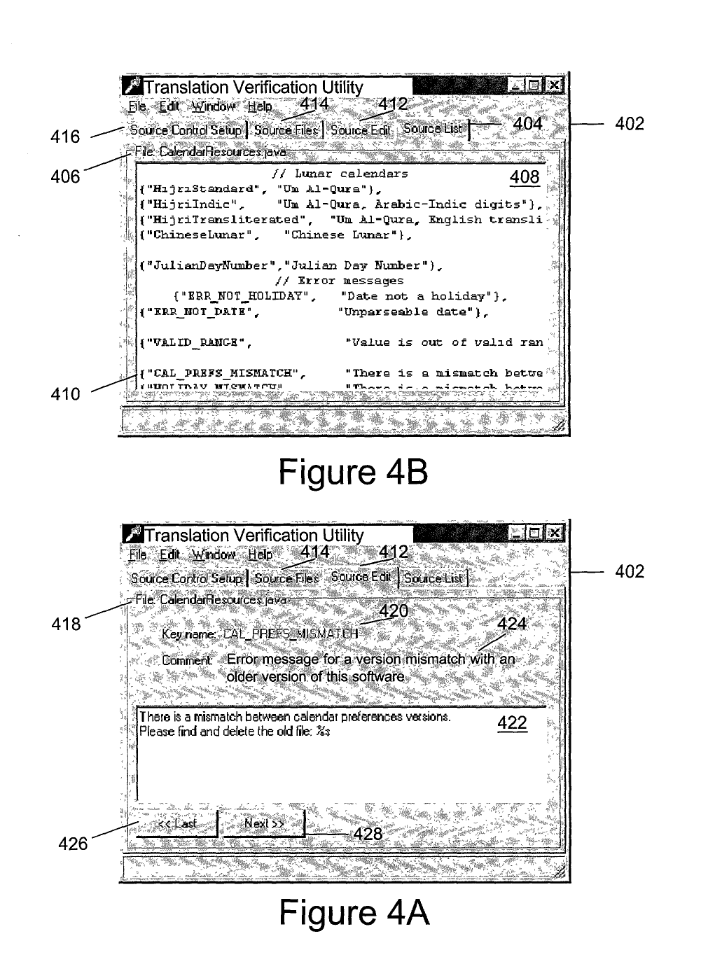

With reference now to FIGS. 4A-4B, a set of graphical user interface (GUI) windows depict a manner in which a user may interact with the translation verification utility of the present invention. FIG. 4A shows window 402 for the translation verification utility of the present invention. Tab 404 allows a user to select a subwindow that shows a listing of the content within the current source file that is being verified by a user. Label 406 provides the name of the current file, and content area 408 displays the actual content from the current source file. For example, message 410 is similar to message 308 shown in FIG. 3. Tab 412 allows a user to select a subwindow that enables the user to edit the text strings and messages from a source file in a methodical, sequential manner, as described below with respect to FIG. 4B.

Tab 414 allows a user to select a subwindow that enables the user to identify a set of source files to be used as input to the translation verification process. Referring again to FIG. 2, translation verification utility 202 contains source file manager 204 for managing the source files. The user of the translation verification utility may interface with a software configuration management system via a source file manager through the GUI presented by tab 414. Alternatively, the user of the translation verification utility inputs and/or selects, through the GUI, files to be controlled directly by the source file manager.

Tab 416 allows a user to select a subwindow that enables the user to enter configuration parameters to be used by the translation verification utility. Specifically, in additional to other types of configuration parameters, a particular user may request to review only those files associated with localizing the application for a particular locale. For example, the user may request to review only those files that contain messages or strings that have been translated into French, whereas another user may review those files that contain messages or strings that have been translated into Arabic.

Referring to FIG. 4B, window 402 is shown after a user has selected tab 412. Label 418 again shows the name of the source file that is currently open. A source file contains a series or sequence of translated messages or text strings. Using its knowledge of the type and structure of the current source file, the translation verification utility steps through the message or text strings within the source file by displaying the translated messages or text strings in solitary manner. If more than one source file has been identified by the user, e.g., through the GUI presented by tab 414, then the translation verification utility will open those files in an appropriate order for subsequent verification of their translated messages by the user.

Key name 420 is the key or identifier that is associated with the message that is currently being shown within message area 422. The user of the translation verification utility can view the message, and if the message contains a translation error, the user can edit the message within message area 422 to correct the error. Message area 422 contains only one message or text string at a time. When another message or text string is retrieved from a source file, the newly retrieved item replaces the currently viewed item, thereby resetting the display to focus on the newly retrieved item. It should be noted that the retrieval or storage of text strings to the source file may be supplemented with the use of caches or other data structures such that retrieval or storage may be performed indirectly.

Comment text 424 is the comment text that is associated with the message within message area 422. Depending on the structure of the message file, the source parser within the translation verification utility can retrieve a comment or other information that is associated with the message and display the associated information in a read-only manner. In this manner, the verifier is provided with context information that assists the verifier in a decision as to whether the message or other text string appears to have been translated correctly.

“LAST” button 426 allows the verifying user to return to the previously viewed text string or a text string that logically proceeds, in some manner, the currently viewed text string within a source file (or the previous source file if there are multiple source files being used). “NEXT” button 428 allows the verifying user to proceed to the translated message or text string that logically follows, in some manner, the currently viewed text string within a source file (or the next source file if there are multiple source files being used). By using these buttons, the verifying user can step or “walk” through the translated messages or strings, which are displayed in a solitary manner in response to the user's requested actions; only one message or text string is displayed at a time to the user. When a user selects button 426, button 428 or a similar type of control, the display that is presented by the translation verification utility changes such that the user can view a text string from the source file that is different from the text string that was being viewed prior to the user selecting the control; the switch between text strings is done automatically without further input from the user.

Alternatively, a variety of “movement” controls could be provided to the user to select a particular text string to be viewed. For example, the user could use a “VERIFIED” button to positively indicate that the translated text string has been verified; in this case, using the “LAST” or “NEXT” button may merely move the current focus to another translated text string without recording that the translated text string has been verified. This arrangement of controls would be useful for allowing the verifying user to scan translated messages without making a verification determination, thereby allowing the user to skip some messages that may require more effort. Other buttons could be provided to the user, such as a “SAVE” button or a “CANCEL” button, to allow the user to control whether or not changes to a text string should be saved after a user has made any changes to the text string with message area 422.

As the messages or strings are shown to the user and possibly edited by the user, the translation verification utility may log information concerning the identity of the verifying user, the date and time at which a translated string or file was verified, and whether the user modified a particular translated text string. In this manner, quality control may be performed to ensure that mistakes within the translation process and the translation verification process are minimized.

Other information associated with the source file or a particular text string could shown to the user. For example, the translation verification utility could display the number of messages that have been reviewed by the user from a particular source file and the number of messages that are left to be reviewed by the user within the source file. Assuming that the utility may be tracking the user's actions for logging purposes, as the user moves logically forward or backward through the source file, the translation verification utility could display an indicator to the user as to whether the user has previously viewed a particular message. These types of features could be especially beneficial during the development of a large application because the user may not review all messages in a single session but may require several sessions to review all of the translated messages for the application that is being developed. Moreover, multiple users could verify different sets of translated messages for an application.

Given that the review of the translated messages for an application under development might involve multiple users over multiple sessions, other review controls could be provided to allow the users to move through the messages according to the tracking/logging information that is generated by the translation verification utility. By scanning past logs, the utility could determine which messages have not yet been reviewed, either completely unreviewed or partially unreviewed by a particular user, and the utility could then present those messages to the user. Hence, the review controls could include the ability for a verifying user to review subsets of messages within the source files that are associated with a particular application. Moreover, the utility could also determine whether or not all messages had been verified, thereby allowing a test engineer to determine whether or not the source files with the translated messages were ready for inclusion within a final, commercially-ready version of the application.

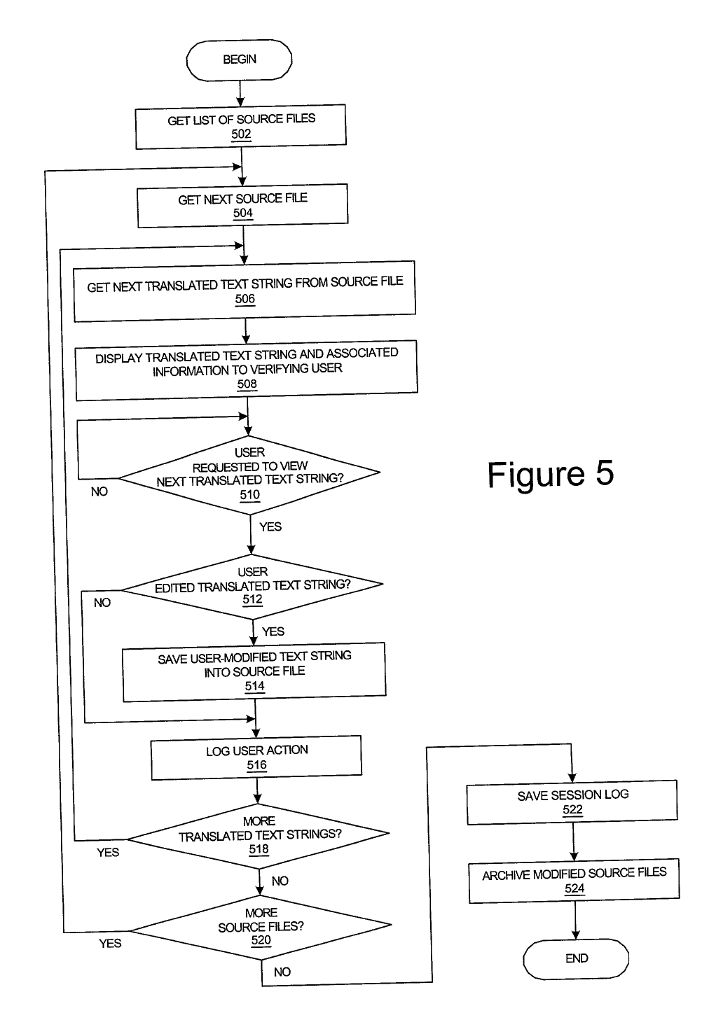

With reference now to FIG. 5, a flowchart depicts a process through which the translation verification utility enables a user to verify translated messages and strings within source files in accordance with a preferred embodiment of the present invention. It should be noted that the process depicted in the flowchart in FIG. 5 assumes that the verifying user continues to move forward sequentially through the messages or text strings within the one or more source files; one of ordinary skill in the art would understand that the translation verification utility would be able to move forward and backward through the items to be displayed to the user in a variety of manner as described above with respect to FIG. 4B.

The process begins with a retrieval of a list of source files (step 502). The list of one or more source files may be originated in a variety of ways: the list of source files could be selected or entered by the user; the translation verification utility could be configured to search for appropriate source files associated with a specified application; the translation verification utility could interface with a software configuration management system to obtain a list of source files; and/or some other equivalent methodology for determining a set of files that are associated with a particular application.

A source file that is identified within the list of source files is retrieved (step 504). A translated text string and any associated information, such as a comment and its key, are retrieved from the source file (step 506) and displayed to the verifying user (step 508). The user may edit the translated text string to correct an incorrectly translated string or message or may request to view the next message. A determination is made as to whether the user has requested to view the next message (step 510); if not, then the translation verification utility cycles in a wait loop for the next user action.

If the user has requested to view the next message, then a determination is made as to whether the user has edited the translated text string (step 512). If so, then the modified text string is saved into the source file or a copy of the source file, as appropriate (step 514). If the user has not modified the text string, then the process does not save the modified text string. In either case, the translation verification utility could log the user's action, including an indication of whether the translated text string was edited, verified, skipped, etc. (step 516).

A determination is then made as to whether there are more translated text strings to be verified within the current source file (step 518). If so, then the process branches back to step 506 to obtain and process another translated text string. Otherwise, the process continues by determining whether there is another source file with translated text strings that have not yet been verified (step 520). If so, then the process branches back to step 504 to get another source file from the list of source files. Otherwise, the translation verification utility may save a log of the current session (step 522), if necessary or appropriate, and then archive or store any modified source files (step 524). The process of stepping through a set of translated text strings using a translation verification utility is then complete.

The advantages of the present invention should be apparent in view of the detailed description of the invention that is provided above. Although translated text strings, including warning and error messages, are often congregated within certain types of files, such as resource files, which could be edited by a person who is performing a translation verification process, human scanning of one or more large text files can itself be an error-prone process such that the person performing the verification could easily miss translation errors within the file. In contrast, the present invention presents the translated text strings one-by-one for verification by a user in a controlled manner. The translated text strings could be viewed and controlled in accordance with logging or tracking data that assists one or more users across multiple review sessions to determine which translated text strings have not yet been verified. The sources of the application strings can be managed by the verification tool, and other verification management options can be performed, such as logging the persons that have verified particular strings.

Moreover, viewing and editing a string or message within a text file does not represent operational conditions within the application. By presenting an error message within a window similar to a dialog box that might be used by the application during runtime, the person performing the verification can focus on one particular string at a time in a manner similar to a user of the final, commercially available version of the application.

Other contextual information can be shown to the verifier at the time that the translated text string is displayed to the verifier, such as the key that identifies the text string and any comment line that might appear within a resource file along with the text string. The contextual information assists the verifier in determining whether or not the text string has been translated correctly.

It is important to note that while the present invention has been described in the context of a fully functioning data processing system, those of ordinary skill in the art will appreciate that some of the processes associated with the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for reviewing text strings within a graphical user interface of a data processing system, the method comprising:
identifying a source file, wherein the source file comprises a plurality of key-value pairs, wherein each key-value pair has a key that identifies a text string;
retrieving a first text string from the source file;
displaying the first text string within an editable field within a window;
receiving a user indication that the first text string is a verified text string;
in response to a user selection of a first control within the window, automatically retrieving a second text string from the source file; and
automatically displaying the second text string within the editable field within the window, thereby replacing the first text string with the second text string within the window.

2. The method of claim 1 wherein the user selection of the first control within the window provides the user indication that the first text string is a verified text string.

3. The method of claim 1 wherein user selection of a second control within the window provides the user indication that the first text string is a verified text string.

4. The method of claim 1 further comprising:
tracking user actions within the window with respect to text strings from the source file.

5. The method of claim 1 further comprising:
recording within a log file user actions within the window with respect to text strings from the source file.

6. The method of claim 1 further comprising:
displaying within the window the key associated within the first text string while the first text string is displayed within the window.

7. The method of claim 1 further comprising:
retrieving information associated with the first text string; and
displaying within the window the information associated within the first text string while the first text string is displayed within the window.

8. The method of claim 1 further comprising:
identifying, as the second text string, a next text string that is logically subsequent to the first text string.

9. The method of claim 8 further comprising:
determining that the next text string is a text string that positionally follows the first text string within the source file.

10. The method of claim 8 further comprising:
determining that the next text string is a text string that immediately positionally follows the first text string within the source file.

11. The method of claim 8 further comprising:
determining that the next text string is a text string that has a logical relationship with the first text string in accordance with tracking information associated with user actions within the window.

12. The method of claim 1 further comprising:
identifying, as the second text string, a next text string that is logically precedent to the first text string.

13. The method of claim 12 further comprising:
determining that the next text string is a text string that has a logical relationship with the first text string in accordance with tracking information associated with user actions within the window.

14. The method of claim 1 further comprising:
editing the first text string; and
saving the first text string to the source file.

15. A data processing system for reviewing text strings within a graphical user interface, the data processing system comprising:
means for identifying a source file, wherein the source file comprises a plurality of key-value pairs, wherein each key-value pair has a key that identifies a text string;
means for retrieving a first text string from the source file;
means for displaying the first text string within an editable field within a window;
means for receiving a user indication that the first text string is a verified text string;
means for automatically retrieving a second text string from the source file in response to a user selection of a first control within the window; and
means for automatically displaying the second text string within the editable field within the window, thereby replacing the first text string with the second text string within the window.

16. The data processing system of claim 15 further comprising:
means for providing the user indication that the first text string is a verified text string during the user selection of the first control within the window.

17. The data processing system of claim 15 further comprising:
means for providing the user indication that the first text string is a verified text string during user selection of a second control within the window.

18. The data processing system of claim 15 further comprising:
means for tracking user actions within the window with respect to text strings from the source file.

19. The data processing system of claim 15 further comprising:
means for recording within a log file user actions within the window with respect to text strings from the source file.

20. The data processing system of claim 15 further comprising:
means for identifying, as the second text string, a next text string that is logically subsequent to the first text string.

21. The data processing system of claim 20 further comprising:
means for determining that the next text string is a text string that positionally follows the first text string within the source file.

22. The data processing system of claim 20 further comprising:
means for determining that the next text string is a text string that has a logical relationship with the first text string in accordance with tracking information associated with user actions within the window.

23. The data processing system of claim 15 further comprising:
means for identifying, as the second text string, a next text string that is logically precedent to the first text string.

24. The data processing system of claim 23 further comprising:
means for determining that the next text string is a text string that has a logical relationship with the first text string in accordance with tracking information associated with user actions within the window.

25. A computer program product in a computer readable medium for use in a data processing system for reviewing text strings within a graphical user interface, the computer program product comprising:
instructions for identifying a source file, wherein the source file comprises a plurality of key-value pairs, wherein each key-value pair has a key that identifies a text string;
instructions for retrieving a first text string from the source file;
instructions for displaying the first text string within an editable field within a window;
instructions for receiving a user indication that the first text string is a verified text string;
instructions for automatically retrieving a second text string from the source file in response to a user selection of a first control within the window; and
instructions for automatically displaying the second text string within the editable field within the window, thereby replacing the first text string with the second text string within the window.

26. The computer program product of claim 25 wherein the user selection of the first control within the window provides the user indication that the first text string is a verified text string.

27. The computer program product of claim 25 further comprising:
instructions for user selection of a second control within the window that provides the user indication that the first text string is a verified text string.

28. The computer program product of claim 25 further comprising:
instructions for tracking user actions within the window with respect to text strings from the source file.

29. The computer program product of claim 25 further comprising:
instructions for identifying, as the second text string, a next text string that is logically subsequent to the first text string.

30. The computer program product of claim 25 further comprising:
instructions for identifying, as the second text string, a next text string that is logically precedent to the first text string.
